(19) United States
(12) Patent Application Publication
(10) Pub. No.: US 2026/0086262 A1
(43) Pub. Date: Mar. 26, 2026

(54) THREE-DIMENSIONAL INVERSION METHOD AND DEVICE FOR ELECTRICAL SOURCE TRANSIENT ELECTROMAGNETIC DATA, AND STORAGE MEDIUM

(71) Applicant: Institute of Geology and Geophysics, Chinese Academy of Sciences, Beijing (CN)

(72) Inventors: Weiying Chen, Beijing (CN); Guoqiang Xue, Beijing (CN); Pengfei Lv, Beijing (CN); Wanting Song, Beijing (CN); Yulian Zhu, Beijing (CN)

(21) Appl. No.: 19/311,154

(22) Filed: Aug. 27, 2025

(30) Foreign Application Priority Data
Sep. 20, 2024 (CN) 2024113146819

(51) Int. Cl. G01V 3/38; G01V 3/12; G01V 3/36; G01V 3/40

(52) U.S. Cl. CPC G01V 3/38; G01V 3/12; G01V 3/36; G01V 3/40

(57) ABSTRACT

Three-dimensional inversion method and device for electrical source transient electromagnetic data, and a storage medium are provided. The method includes: step S1, collecting a vertical induced voltage v_{z} and a horizontal electric field eₓ of electrical source transient electromagnetic; step S2, calculating, by using the vertical induced voltage v_{z} and the horizontal electric field eₓ, an all-time apparent resistivity; step S3, performing, according to the all-time apparent resistivity, time-frequency conversion to obtain frequency-apparent resistivity data of each observation point; and step S4, performing three-dimensional inversion on the frequency-apparent resistivity data by using a three-dimensional magnetotelluric inversion algorithm.

### CROSS-REFERENCE TO RELATED APPLICATION

This application claims priority to Chinese Patent Application No. 202411314681.9, filed on Sep. 20, 2024, which is herein incorporated by reference in its entirety.

### TECHNICAL FIELD

The disclosure relates to the field of geophysical exploration technologies, and more particularly to three-dimensional inversion method and device for electrical source transient electromagnetic data, and a storage medium.

### BACKGROUND

The electrical source transient electromagnetic method is an advantageous means for deep geophysical exploration. At present, processing methods of electrical source transient electromagnetic data are mainly limited to one-dimensional and quasi-two-dimensional. Three-dimensional inversion faces problems such as large amount of calculation, low efficiency, and inability to process multiple transmitting sources, which brings great challenges to the fine processing of the electrical source transient electromagnetic data.

### SUMMARY

A technical problem to be solved by the disclosure is to provide three-dimensional inversion method and device for electrical source transient electromagnetic data and a storage medium, which overcomes influence of a transmitting source, improves an inversion efficiency, and provides a solution for three-dimensional inversion of multi-source data.

In order to achieve the above purpose, the disclosure adopts the following technical solutions.

A three-dimensional inversion method for electrical source transient electromagnetic data includes:
step S1, collecting a vertical induced voltage v_{z} and a horizontal electric field eₓ of electrical source transient electromagnetic;
step S2, calculating, by using the vertical induced voltage v_{z} and the horizontal electric field eₓ, an all-time apparent resistivity;
step S3, performing, according to the all-time apparent resistivity, time-frequency conversion to obtain frequency-apparent resistivity data of each observation point; and
step S4, performing three-dimensional inversion on the frequency-apparent resistivity data.

In an embodiment, the step S2 includes:
calculating first derivatives \dot{v}_{z} and ėₓ of the vertical induced voltage v_{z} and the horizontal electric field eₓ with respect to time respectively, and calculating the all-time apparent resistivity ρ by using the following formula:

$$ρ = \frac{y}{2 t} \cdot \vert \frac{{\dot{e}}_{x}}{{\dot{v}}_{z}} \vert$$

where y represents a vertical distance between an observation point and a transmitting source, and t represents a time.

In an embodiment, the step S4 includes:
performing, by using a three-dimensional magnetotelluric inversion algorithm, the three-dimensional inversion on the frequency-apparent resistivity data.

A three-dimensional inversion method for electrical source transient electromagnetic data includes:
step S1, collecting, through electromagnetic sensors disposed on ground, a vertical induced voltage v_{z} and a horizontal electric field eₓ of electrical source transient electromagnetic;
step S2, calculating, by a processor and by using the vertical induced voltage v_{z} and the horizontal electric field eₓ, an all-time apparent resistivity;
step S3, performing, according to the all-time apparent resistivity, time-frequency conversion to obtain frequency-apparent resistivity data of each observation point;
step S4, performing, by using a three-dimensional inversion program executed by the processor, three-dimensional inversion on the frequency-apparent resistivity data to obtain a three-dimensional inverted resistivity structure; and
step S5, describing, based on the three-dimensional inverted resistivity structure, an underground geological structure of a target area, to thereby achieve deep geophysical exploration of the target area.

The disclosure further provides a three-dimensional inversion device for electrical source transient electromagnetic data, including a collection module, a first calculation module, a second calculation module, and an inversion module. The collection module is configured to collect a vertical induced voltage v_{z} and a horizontal electric field eₓ of electrical source transient electromagnetic. The first calculation module is configured to calculate an all-time apparent resistivity by using the vertical induced voltage v_{z} and the horizontal electric field eₓ. The second calculation module is configured to perform time-frequency conversion according to the all-time apparent resistivity to obtain frequency-apparent resistivity data of each observation point. The inversion module is configured to perform three-dimensional inversion on the frequency-apparent resistivity data.

In an embodiment, each of the collection module, the first calculation module, the second calculation module, and the inversion model is embodied by at least one processor and at least one memory coupled to the at least one processor, and the at least one memory stores computer programs executable by the at least one processor.

In an embodiment, the first calculation module is configured to calculate first derivatives \dot{v}_{z} and ėₓ of the vertical induced voltage v_{z} and the horizontal electric field eₓ with respect to time respectively, and calculate the all-time apparent resistivity ρ by using the following formula:

$$ρ = \frac{y}{2 t} \cdot \vert \frac{{\dot{e}}_{x}}{{\dot{v}}_{z}} \vert$$

where y represents a vertical distance between an observation point and a transmitting source, and t represents a time.

In an embodiment, the inversion module is configured to perform the three-dimensional inversion on the frequency-apparent resistivity data by using a three-dimensional magnetotelluric inversion algorithm.

The disclosure further provides a non-transitory storage medium having a computer program stored therein. The computer program is configured to, when executed, implement the three-dimensional inversion method for electrical source transient electromagnetic data.

The disclosure utilizes the two components of the vertical induced voltage and the horizontal electric field of electrical source transient electromagnetic to define the all-time apparent resistivity that can eliminate the influence of the transmitting source, and proposes an accurate time-frequency conversion relationship, thereby realizing the conversion of time domain signals to frequency domain data. The three-dimensional inversion technology in the magnetotelluric method is further used to invert the converted data, thereby realizing the rapid three-dimensional inversion of the electrical source transient electromagnetic data.

### BRIEF DESCRIPTION OF DRAWINGS

In order to more clearly illustrate embodiments of the disclosure or technical solutions in the related art, drawings required for use in the embodiments or the description of the related art will be briefly introduced below. Apparently, the drawings described below are only embodiments of the disclosure. For those skilled in the art, other drawings can be obtained based on the provided drawings without creative work.

FIG. 1 illustrates a flowchart of a three-dimensional inversion method for electrical source transient electromagnetic data according to an embodiment of the disclosure.

FIG. 2 illustrates a flowchart of three-dimensional inversion processing of converted frequency-apparent resistivity data according to the embodiment of the disclosure.

FIG. 3 illustrates a schematic diagram of a three-dimensional model and a transmit-receive arrangement.

FIG. 4 illustrates a schematic diagram of a three-dimensional inversion result.

### DETAILED DESCRIPTION OF EMBODIMENTS

Technical solutions in embodiments of the disclosure will be clearly and completely described below in conjunction with drawings in the embodiments of the disclosure. Apparently, the described embodiments are merely some of the embodiments of the disclosure, not all of the embodiments. Based on the embodiments of the disclosure, all other embodiments obtained by those skilled in the art without creative work are within a scope of protection of the disclosure.

In order to make the above-mentioned objects, features and advantages of the disclosure more obvious and easy to understand, the disclosure is further described in detail below with reference to the drawings and specific embodiments.

### Embodiment 1

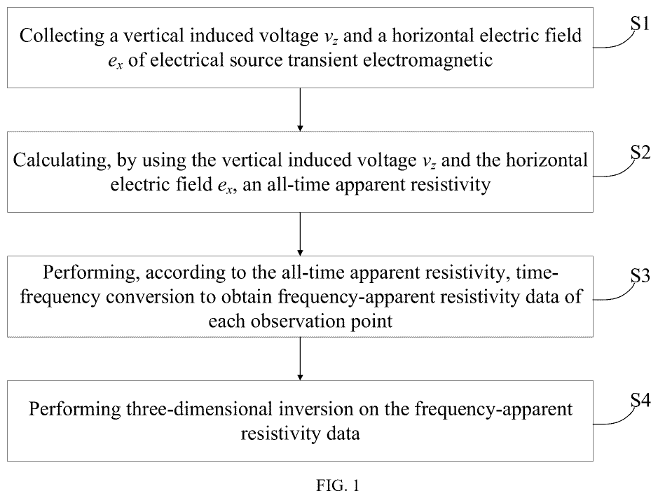

As shown in FIG. 1, the embodiments of the disclosure provide a three-dimensional inversion method for electrical source transient electromagnetic data, including the following steps S1 to S4.

In step S1, a vertical induced voltage v_{z} and a horizontal electric field eₓ of electrical source transient electromagnetic are collected.

In step S2, an all-time apparent resistivity is calculated by using the vertical induced voltage v_{z} and the horizontal electric field eₓ.

In step S3, time-frequency conversion is performed according to the all-time apparent resistivity to obtain frequency-apparent resistivity data of each observation point.

In step S4, three-dimensional inversion is performed on the frequency-apparent resistivity data.

In an embodiment of the disclosure, expressions of the vertical induced voltage v_{z} and the horizontal electric field eₓ generated by a horizontal electrical dipole source on ground surface of a homogeneous half space are as follows:

$${e}_{x} = - \frac{Ids}{{π}^{3 / 2}} \cdot \frac{ρ}{{r}^{3}} \cdot [ {\int }_{0}^{u} {e}^{- {t}^{2}} d t - u {e}^{- {u}^{2}} ] ; \\ {v}_{z} = - \frac{Ids}{{π}^{3 / 2} μ} \cdot \frac{y ρ}{{r}^{5}} \cdot [ 3 {\int }_{0}^{u} {e}^{- {t}^{2}} d t - u ( 3 + 2 {u}^{2} ) {e}^{- {u}^{2}} ] ;$$

where I represents a transmitting current intensity, ds represents a length of the horizontal electrical dipole source, ρ represents a resistivity, r=\sqrt{(x−x′)² (y−y′)²} represents a distance between the observation point (x,y) and the transrnitting source (x′y′),

$$u = \frac{1}{2} \sqrt{\frac{{μ}_{0}}{ρ t}} r$$

represents a variable, and μ₀=4×10⁻⁷ henrys per ampere (H/A) represents a magnetic permeability.

First derivatives of the vertical induced voltage v_{z} and the horizontal electric field eₓ with respect to time t are calculated respectively as follows:

$${\dot{e}}_{x} = \frac{\partial {e}_{x}}{\partial t} = \frac{Ids}{{π}^{3 / 2}} \cdot \frac{ρ}{{r}^{3}} \cdot \frac{1}{t} \cdot {u}^{3} \cdot {e}^{- {u}^{2}} ; \\ {v}_{z} = \frac{\partial {v}_{z}}{\partial t} = - \frac{Ids}{{π}^{3 / 2} μ} \cdot \frac{y ρ}{{r}^{5}} \cdot 2 {u}^{5} \cdot {e}^{- {u}^{2}} \cdot \frac{1}{t} .$$

A ratio between the first derivatives of the vertical induced voltage v_{z} and the horizontal electric field eₓ with respect to time t is solved as follows:

$$\frac{{\dot{e}}_{x}}{{\dot{v}}_{z}} = \frac{2 t ρ}{y} .$$

Thus, the all-time apparent resistivity ρ is obtained as follows:

$$ρ = \frac{y}{2 t} \cdot \vert \frac{{\dot{e}}_{x}}{{\dot{v}}_{z}} \vert ;$$

where y represents a vertical distance between the observation point and the transmitting source, and t represents the time. This resistivity calculation formula can offset the transmitting source term and eliminate the influence of factors such as the transmitting source size, position, and shape.

In an embodiment of the disclosure, in the step S3, the following formula is used to perform time-frequency conversion:

$$f = 150 / t ;$$

where f represents a frequency.

In an embodiment of the disclosure, in the step S4, a three-dimensional magnetotelluric inversion algorithm is used to perform the three-dimensional inversion on the frequency-apparent resistivity data.

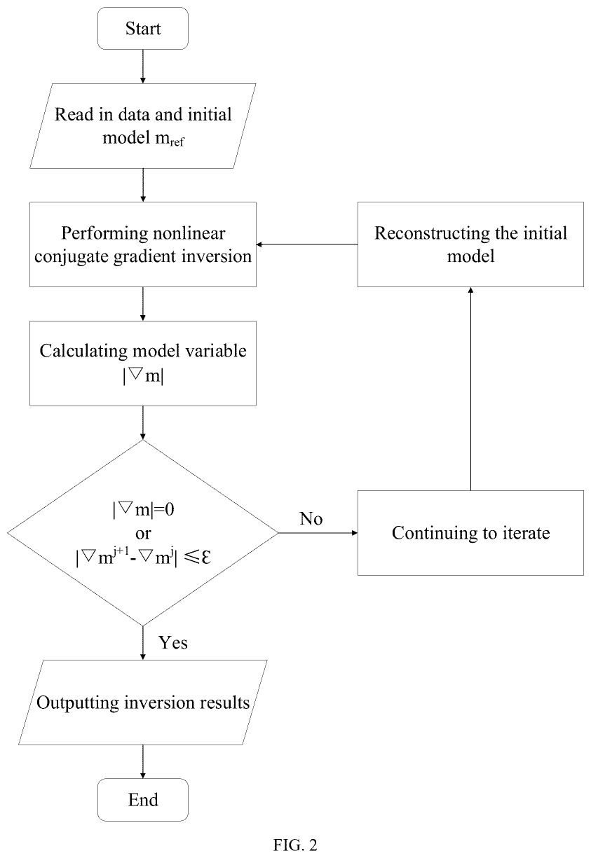

In an embodiment, a three-dimensional inversion program, such as modular electromagnetic inversion program (ModEM), of the magnetotelluric method is used to perform the three-dimensional inversion on the converted frequency-apparent resistivity data. As shown in FIG. 2, the specific steps include the follows. (1) The frequency and the apparent resistivity data after time-frequency conversion, and initial model parameters are read in. (2) Nonlinear conjugate gradient inversion is performed to calculate model change after each iteration, and the model is updated. (3) Whether fitting residual data meets the requirements is determined, when the fitting residual data meets the requirements, the inversion is ended, and the model is output; otherwise, iteration is continued to modify the model. (4) The inversion model that finally meets the fitting residual requirements is obtained, the inversion is ended, and the inversion result is output.

It should be noted that the converted frequency domain data is similar to the transverse electric (TE) polarization field in the magnetotelluric method, thus the TE inversion mode needs to be used in the inversion.

### Numerical Example

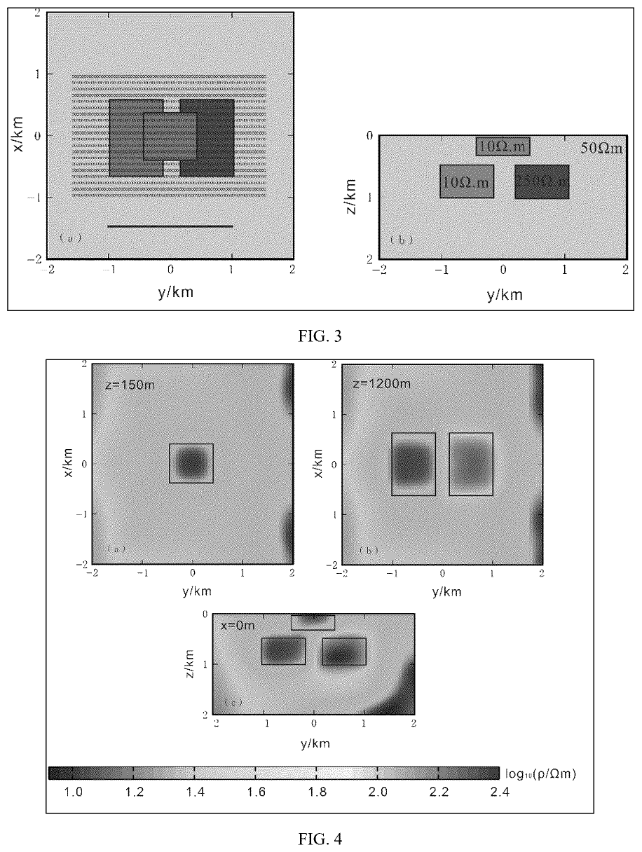

A three-dimensional model of multiple anomalies is designed as shown in FIG. 3, and a background resistivity of the model is 50 ohms-meter (Ω·m). Three anomalies are designed in total, the resistivities of low-resistance anomalies in the shallow and deep parts each are 10 Ω·m, and the resistivity of high-resistance anomaly in the deep part is 250 Ω·m. A size of the anomaly in the shallow part is 600 meters (m)×600 m×250 m, and a top buried depth is 20 m. Sizes of the two anomalies in the deep part each are 1200 m×800 m×500 m, and top buried depths are 500 m. A length of the electrical source transient electromagnetic transmitting source is 2 kilometers (km), and a sampling time is in a range of 0.1 millisecond (ms) to 50 ms. A survey line offset is in a range of 500 m to 1500 m, with a total of 20 survey lines. A length of each survey line is 3 km, and a point spacing is 20 m.

First, the three-dimensional model is forward modeled to obtain v_{z} and eₓ responses of all observation points. Then, the all-time apparent resistivity is calculated. The time-frequency conversion is performed to obtain frequency domain data (i.e., frequency-apparent resistivity data). Finally, the open source program ModEM is used to perform the three-dimensional inversion on the converted frequency domain data to obtain a three-dimensional inverted resistivity structure, as shown in FIG. 4.

The result shows that the three-dimensional inversion method for electrical source transient electromagnetic data of the embodiment of the disclosure can better restore a three-dimensional electrical structure of a real model, verifying the feasibility and effectiveness of the method. At the same time, compared with direct three-dimensional inversion of time domain data, the calculation efficiency can be improved by more than 5 times, the new method takes about 1 hour, and the traditional method takes about 5 hours.

### Embodiment 2

The disclosure further provides a three-dimensional inversion device for electrical source transient electromagnetic data, including a collection module, a first calculation module, a second calculation module, and an inversion module. The collection module is configured to collect a vertical induced voltage v_{z} and a horizontal electric field eₓ of electrical source transient electromagnetic. The first calculation module is configured to calculate an all-time apparent resistivity by using the vertical induced voltage v_{z} and the horizontal electric field eₓ. The second calculation module is configured to perform time-frequency conversion according to the all-time apparent resistivity to obtain frequency-apparent resistivity data of each observation point. The inversion module is configured to perform three-dimensional inversion on the frequency-apparent resistivity data.

In an embodiment, the first calculation module is configured to calculate first derivatives \dot{v}_{z} and ėₓ of the vertical induced voltage v_{z} and the horizontal electric field eₓ with respect to time respectively, and calculate the all-time apparent resistivity ρ by using the following formula:

$$ρ = \frac{y}{2 t} \cdot \vert \frac{{\dot{e}}_{x}}{{\dot{v}}_{z}} \vert$$

where y represents a vertical distance between an observation point and a transmitting source, and t represents a time.

In an embodiment, the inversion module is configured to perform the three-dimensional inversion on the frequency-apparent resistivity data by using a three-dimensional magnetotelluric inversion algorithm.

### Embodiment 3

The disclosure further provides a non-transitory storage medium having a computer program stored therein. The computer program is configured to, when executed, implement the three-dimensional inversion method for electrical source transient electromagnetic data.

The embodiments described above are only descriptions of the embodiments of the disclosure and are not intended to limit the scope of the disclosure. Without departing from a design spirit of the disclosure, various modifications and improvements made to the technical solutions of the disclosure by those skilled in the art should all fall within the protection scope determined by the claims of the disclosure.

What is claimed is:

1. A three-dimensional inversion method for electrical source transient electromagnetic data, comprising:
step S1, collecting a vertical induced voltage v_{z} and a horizontal electric field eₓ of electrical source transient electromagnetic;
step S2, calculating, by using the vertical induced voltage v_{z} and the horizontal electric field eₓ, an all-time apparent resistivity;
step S3, performing, according to the all-time apparent resistivity, time-frequency conversion to obtain frequency-apparent resistivity data of each observation point; and
step S4, performing three-dimensional inversion on the frequency-apparent resistivity data; and
wherein the step S2 comprises:
calculating first derivatives \dot{v}_{z} and ėₓ of the vertical induced voltage v_{z} and the horizontal electric field eₓ with respect to time respectively, and calculating the all-time apparent resistivity ρ by using the following formula:
$$ρ = \frac{y}{2 t} \cdot \vert \frac{{\dot{e}}_{x}}{{\dot{v}}_{z}} \vert$$
wherein y represents a vertical distance between an observation point and a transmitting source, and t represents a time.

2. The three-dimensional inversion method for electrical source transient electromagnetic data as claimed in claim 1, wherein the step S4 comprises:
performing, by using a three-dimensional magnetotelluric inversion algorithm, the three-dimensional inversion on the frequency-apparent resistivity data.

3. A three-dimensional inversion device for electrical source transient electromagnetic data, comprising:
a collection module, configured to collect a vertical induced voltage v_{z} and a horizontal electric field eₓ of electrical source transient electromagnetic;
a first calculation module, configured to calculate an all-time apparent resistivity by using the vertical induced voltage v_{z} and the horizontal electric field eₓ;
a second calculation module, configured to perform time-frequency conversion according to the all-time apparent resistivity to obtain frequency-apparent resistivity data of each observation point; and
an inversion module, configured to perform three-dimensional inversion on the frequency-apparent resistivity data; and
wherein the first calculation module is configured to calculate first derivatives \dot{v}_{z} and ėₓ of the vertical induced voltage v_{z} and the horizontal electric field eₓ with respect to time respectively, and calculate the all-time apparent resistivity ρ by using the following formula:
$$ρ = \frac{y}{2 t} \cdot \vert \frac{{\dot{e}}_{x}}{{\dot{v}}_{z}} \vert$$
wherein y represents a vertical distance between an observation point and a transmitting source, and t represents a time.

4. The three-dimensional inversion device for electrical source transient electromagnetic data as claimed in claim 3, wherein the inversion module is configured to perform the three-dimensional inversion on the frequency-apparent resistivity data by using a three-dimensional magnetotelluric inversion algorithm.

5. A storage medium having a computer program stored therein, wherein the computer program is configured to, when executed, implement the three-dimensional inversion method for electrical source transient electromagnetic data as claimed in claim 1.
